(19) United States
(12) Patent Application Publication
(10) Pub. No.: US 2026/0204606 A1
(43) Pub. Date: Jul. 16, 2026

(54) PRODUCTION OF SYNGAS FROM METHANE

(71) Applicant: TOTALENERGIES ONETECH, Courbevoie (FR)

(72) Inventors: Miroslav KETTNER, Seneffe (BE); Gleb VERYASOV, Seneffe (BE); Nikolai NESTERENKO, Nivelles (Thines) (BE)

(21) Appl. No.: 19/135,336

(22) PCT Filed: Jan. 11, 2024
(86) PCT No.: PCT/EP2024/050542

§ 371 Date: Jun. 3, 2025

(30) Foreign Application Priority Data
Jan. 16, 2023 (EP) 23315005.1

(51) Int. Cl. H01M 8/0612; C01B 3/36; C01B 3/382; H01M 8/12; H01M 8/1231; H01M 8/1246

(52) U.S. Cl. CPC H01M 8/0618; C01B 3/36; C01B 3/382; H01M 8/1231; H01M 8/1246; C01B 2203/0233; C01B 2203/025; C01B 2203/067; C01B 2203/1241; C01B 2203/84; H01M 2008/1293; H01M 2250/10

(57) ABSTRACT

The disclosure concerns a process for producing syngas from methane remarkable in that it comprises the steps of (a) providing one or more solid oxide fuel cells (1); (b) providing an oxygen-rich stream to generate oxygen ions; (c) providing methane; (d) performing at least a POX reaction of the methane with the oxygen from the oxygen ions generated at step (b) to produce syngas; (e) providing one protonic membrane reformer (9) and a stream (11) comprising methane and water and (f) performing within the reformer a steam methane reforming reaction to generate syngas and recovering from said syngas at least a carbon oxides-containing stream (13) that is at least partially mixed to the anode feed stream (5) provided at step (c).

### TECHNICAL FIELD

The present disclosure relates to a process for producing syngas from methane.

### TECHNICAL BACKGROUND

Syngas is a combination of hydrogen and carbon oxides (mainly carbon monoxide) that is valuable in the production of fuels, olefins and/or aromatics. The ideal ratio between the hydrogen and the carbon monoxide for implementing the Fischer-Tropsch process or the methanol synthesis is a ratio of 2/1.

Steam methane reforming (SMR), illustrated by the equation below, has been widely used for syngas production.

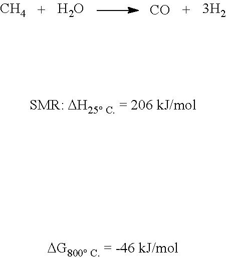

However, the ratio between the hydrogen and the carbon monoxide that is reached is 3/1, which is not ideal for further use of the syngas.

A second way to obtain syngas is to implement the dry methane reforming (DMR) reaction, according to the following equation:

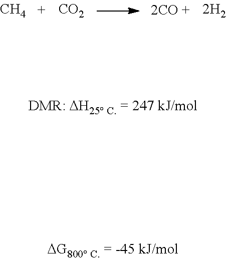

However, this process is endothermic at room temperature and the ratio between the hydrogen and the carbon monoxide that is reached is 1/1, namely not suitable for further applications.

Another way could be to implement partial oxidation (POX) reaction of methane, for example within a solid oxide fuel cell.

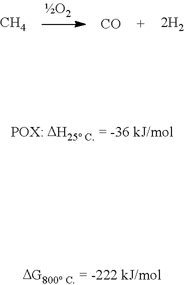

Although the ratio between hydrogen and carbon monoxide is 2/1, this reaction is not straightforward since methane burning can lead to other products. Also, the produced stream is intrinsically mixed and the nature of the reaction does not allow for changing the H₂/CO ratio. The exothermicity of the POX is also not sufficient to obtain an elevated efficiency of the reaction.

As both the POX and DMR reactions are conducted on the anode side of an electrochemical cell, it is possible to combine them to yield syngas:

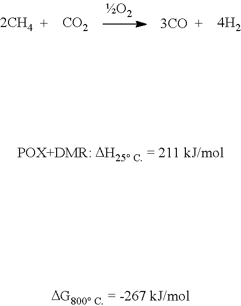

However, the endothermicity of this combination is a drawback, as well as the obtaining of syngas with a non-ideal ratio of 4/3 between hydrogen and carbon monoxide.

U.S. Pat. No. 8,071,241 relates to a solid oxide fuel cell with a downstream hydrogen separator which can comprise a proton exchange membrane. The solid oxide fuel cell generates a methane fuel and/or a hydrogen fuel.

The objective of this disclosure is therefore to provide a technology for producing syngas in an ideal hydrogen/carbon monoxide ratio of 2/1 and that is overall exothermic.

### SUMMARY

According to a first aspect, the disclosure relates to a process for producing syngas from methane, the process is remarkable in that it comprises the steps:
a) providing one or more solid oxide fuel cells, wherein each of said one or more solid oxide fuel cells has an anode and a cathode and comprises a solid oxide electrolyte between the anode and the cathode; further wherein the anode, the cathode and the solid oxide electrolyte are each composed of one or more ceramic materials;
b) providing a cathode feed stream at the cathode of the one or more solid oxide fuel cells, said cathode feed stream being an oxygen-rich stream, to generate oxygen ions diffusing to the anode of the one or more solid oxide fuel cells through the solid oxide electrolyte;
c) providing an anode feed stream at the anode of the one or more solid oxide fuel cells, said anode feed stream comprising methane;
d) performing at least a partial oxidation reaction of the methane of the anode feed stream with the oxygen from the oxygen ions generated at step (b) to produce an anodic effluent stream comprising syngas;
e) providing one or more protonic membrane reformers, and a stream comprising methane and water;
f) within said one or more protonic membrane reformers:
   performing a steam methane reforming reaction with the stream comprising methane and water to generate syngas; and
   recovering from said syngas at least a carbon oxides-containing stream, said carbon oxides-containing stream being at least partially mixed to the anode feed stream provided at step (c).

More particularly, the disclosure relates to a process for producing syngas from methane, the process is remarkable in that it comprises the steps:
a) providing one or more solid oxide fuel cells, wherein each of said one or more solid oxide fuel cells has an anode and a cathode and comprises a solid oxide electrolyte between the anode and the cathode; further wherein the anode, the cathode and the solid oxide electrolyte are each composed of one or more ceramic materials;
b) providing a cathode feed stream at the cathode of the one or more solid oxide fuel cells, said cathode feed stream being an oxygen-rich stream, to generate oxygen ions diffusing to the anode of the one or more solid oxide fuel cells through the solid oxide electrolyte;
c) providing an anode feed stream at the anode of the one or more solid oxide fuel cells, said anode feed stream comprising methane;
d) performing at least a partial oxidation reaction of the methane of the anode feed stream with the oxygen from the oxygen ions generated at step (b) to produce an anodic effluent stream comprising syngas;
e) providing one or more protonic membrane reformers, and a stream comprising methane and water;
f) within said one or more protonic membrane reformers:
   performing a steam methane reforming reaction with the stream comprising methane and water to generate syngas; and
   recovering from said syngas at least a carbon oxides-containing stream, said carbon oxides-containing stream being at least partially mixed to the anode feed stream provided at step (c); and
wherein each of said one or more protonic membrane reformers has an anode and a cathode, and the anode of said each of the one or more protonic membrane reformers is directly adjacent with the anode of said each of the one or more solid oxide fuel cells provided at step (a); and/or
wherein step (a) is the step of providing at least one solid oxide fuel cell presenting a solid oxide electrolyte into which one protonic membrane reformer provided at step (e) is inserted.

Surprisingly, it was found that the combination of one or more solid oxide fuel cells with one or more protonic membrane reformers allows forming, as an anodic effluent stream of the solid oxide fuel cells, a syngas stream from methane in an ideal ratio between the hydrogen and the carbon monoxide of 2/1 where part of the hydrogen is separated. Indeed, the protonic membrane reformers are used to generate a carbon oxides-containing stream which is injected into the one or more solid oxide fuel cells. The protonic membrane reformers are also used to recover form the syngas at least a carbon oxides-containing stream, allowing to enhance the conversion of methane into syngas via the POX or SMR process by adjusting the molar ratio between the hydrogen and the carbon monoxide as desired.

Advantageously, step (d) also produces electrical energy. With preference, said electrical energy is used to work the one or more protonic membrane reformers provided at step (c).

Advantageously, the carbon oxides-containing stream has a molar ratio (CO+CO₂)/H₂ of at least 0.5, preferably at least 0.75, and more preferably at least 0.90.

Advantageously, recovering from said syngas at least a carbon oxides-containing stream also comprises removing at least 40 vol. % of hydrogen based on the total volume content of the hydrogen in the syngas as determined by gas chromatography analysis, or at least 50 vol. %, more preferably at least 55 vol. %, even more preferably at least 60 vol. %, most preferably at least 65 vol. %, even most preferably at least 70 vol. %, or at least 80 vol. %, or at least 90 vol. %, or at least 95 vol. %, or at least 99 vol. % of hydrogen.

Advantageously, the carbon oxides-containing stream comprises at least 1 mol. % of hydrogen based on the total molar content of the carbon oxides-containing stream, preferably at least 2 mol. %, more preferably at least 3 mol. %, even more preferably at least 4 mol. %, most preferably at least 5 mol. %. For example, the carbon oxides-containing stream comprises at most 67 mol. % of hydrogen based on the total molar content of the carbon oxides-containing stream, preferably at most 65 mol. %, more preferably at most 60 mol. %, even more preferably at most 55 mol. %, most preferably at most 50 mol. %, or at most 45 mol. %, or at most 40 mol. %, or at most 35 mol. %, or at most 30 mol. %. For example, the carbon oxides-containing stream comprises between 1 mol. % and 67 mol. % of hydrogen based on the total molar content of the carbon oxides-containing stream, preferably between 2 mol. % and 65 mol. %, more preferably between 3 mol. % and 60 mol. %, even more preferably between 4 mol. % and 55 mol. %, most preferably between 5 mol. % and 50 mol. %.

For example, at least a part of the carbon oxides-containing stream is separated into a carbon dioxide stream and a carbon monoxide stream. With preference, said carbon dioxide stream is mixed to the anode feed stream of the solid oxide fuel cell.

For example, at least a part of the anodic effluent stream is separated into a carbon dioxide stream and a carbon monoxide stream. With preference, said carbon dioxide stream is mixed to the anode feed stream of the solid oxide fuel cell.

With preference, recovering from said syngas at least a carbon oxides-containing stream also comprises recovering a hydrogen stream from said syngas. More preferably, said hydrogen stream is at least partially mixed to the anode feed stream provided at step (c) and/or to the anodic effluent stream produced at step (d).

Advantageously, the process comprises a step of providing one or more additional solid oxide fuel cells, wherein each of said one or more additional solid oxide fuel cells have an anode and a cathode and comprise a solid oxide electrolyte between the anode and the cathode; further wherein the anode, the cathode and the solid oxide electrolyte are each composed of one or more ceramic materials and wherein a cathode feed stream is provided at the cathode of the one or more additional solid oxide fuel cells, said cathode feed stream being an oxygen-rich stream, to generate oxygen ions diffusing to the anode of the one or more additional solid oxide fuel cells through the solid oxide electrolyte, and wherein at least a part of the hydrogen stream is mixed to the anode of said one or more additional solid oxide fuel cells and/or to the anode feed stream provided at step (c) to produce additional electrical energy.

With preference, said additional electrical energy is used to work the one or more protonic membrane reformers provided in step (e).

Advantageously, in an embodiment, each of said one or more protonic membrane reformers has an anode and a cathode, and the anode of said each of the one or more protonic membrane reformers is directly adjacent to the anode of said each of the one or more solid oxide fuel cells provided at step (a). For example, the process is performed in an installation made of a stack of four flat cells, wherein the first cell is a first solid oxide fuel cell, the second cell is a first protonic membrane reformer and is placed contiguously with the first cell, the third cell is a second protonic membrane reformer and is placed contiguously with the second cell, and the fourth cell is a second solid oxide fuel cell and is placed contiguously with the third cell. Alternatively, the process is performed in an installation made of a stack of four flat cells, wherein the first cell is a first protonic membrane reformer, the second cell is a first solid oxide fuel cell and is placed contiguously with the first cell, the third cell is a second solid oxide fuel cell and is placed contiguously with the second cell, and the fourth cell is a second protonic membrane reformer and is placed contiguously with the third cell.

For example, the anode of the one or more protonic membrane reformers is directly adjacent to the anode of the one or more solid oxide fuel cells.

Advantageously, in an alternative embodiment, step (a) is the step of providing one solid oxide fuel cell presenting a solid oxide electrolyte into which the protonic membrane reformer provided at step (e) is inserted. For example, the process is performed in an installation made of a solid oxide fuel cell shaped as a tubular reactor into which a protonic membrane reformer in the form of a tube is inserted.

For example, the one or more solid oxide fuel cells comprises a solid oxide electrolyte; and the one or more protonic membrane reformers are inserted into said solid oxide electrolyte.

Whatever the embodiment selected, the following features can be advantageously applied to the present process:
The anode feed stream provided at step (c) is a stream of natural gas, biogas, fuel gas, sour gas, or any mixture thereof.
The process further comprises the step of adding water into the anode feed stream provided in step (c). With preference, the molar amount of water in the anode feed stream is ranging between 0 mol. % and 20 mol. % based on the total molar content of the anode feed stream provided at step (c), more preferably between 1 mol. % and 12 mol. %, or between 2 mol. % and 11 mol. %.
The cathode feed stream provided at step (b) is air.
The process comprises the step of adding carbon dioxide into the anode feed stream provided in step (c). For example, the molar ratio in the anode feed stream provided at step (c) between the amount of methane and the amount of carbon dioxide is at least 1/1, preferably at least 1.5/1, more preferably at least 2/1, and even more preferably at least 3/1.
The one or more protonic membrane reformers provided at step (e) are operated at a temperature which is equal to or inferior to the temperature used in the one or more solid oxide fuel cells or in the one or more additional solid oxide fuel cells.
For example, the one or more protonic membrane reformers provided at step (e) are operated at a temperature ranging between 400° C. and 900° C., preferably between 450° C. and 850° C., more preferably between 500° C. and 800° C.
For example, the one or more solid oxide fuel cells are operated at a temperature ranging between 600° C. and 1000° C., preferably between 650° C. and 950° C., more preferably between 700° C. and 900° C.
For example, the one or more additional solid oxide fuel cells are operated at a temperature ranging between 600° C. and 1000° C., preferably between 650° C. and 950° C., more preferably between 700° C. and 900° C.
For example, the one or more protonic membrane reformers are operated at a current density that is ranging between 0.2 A/cm² and 10 A/cm², or between 0.2 A/cm² and 8 A/cm², or between 0.2 A/cm² and 6 A/cm², or between 0.2 A/cm² and 5 A/cm², preferably between 0.4 A/cm² and 4 A/cm².
For example, the one or more solid oxide fuel cells are operated at a current density that is ranging between 0.05 A/cm² and 5 A/cm², or between 0.1 A/cm² and 4 A/cm², or between 0.2 A/cm² and 3 A/cm², or between 0.2 A/cm² and 2 A/cm², preferably between 0.2 A/cm² and 1.8 A/cm², more preferably between 0.2 A/cm² and 1.6 A/cm², even more preferably between 0.2 A/cm² and 1.4 A/cm².
For example, the one or more additional solid oxide fuel cells are operated at a current density that is ranging between 0.05 A/cm² and 5 A/cm², or between 0.1 A/cm² and 4 A/cm², or between 0.2 A/cm² and 3 A/cm², or between 0.2 A/cm² and 2 A/cm², preferably between 0.2 A/cm² and 1.8 A/cm², more preferably between 0.2 A/cm² and 1.6 A/cm², even more preferably between 0.2 A/cm² and 1.4 A/cm².

Advantageously, the one or more ceramic materials are one or more mixed oxides.

Advantageously, the one or more solid oxide electrolyser cells comprise a layer between the anode and the solid oxide electrolyte and/or between the cathode and the solid oxide electrolyte, wherein said layer is made of one or more ceramic materials, more preferably of one or more mixed oxides.

With preference, the one or more mixed oxides are doped with one or more lower-valent cations. With preference, said one or more mixed oxides are selected from:
one or more oxides having a cubic fluorite structure being at least partially substituted with one or more lower-valent cations, preferentially selected from Sm, Gd, Y, Sc, Yb, Mg, Ca, La, Dy, Er, Eu, Ba; and/or
one or more ABO₃-perovskites with A and B tri-valent cations, being at least partially substituted in A position with one or more lower-valent cations, preferentially selected from Ca, Sr, or Mg, and comprising one or more selected from Ni, Ga, Co, Cr, Mn, Sc, Fe and any mixture thereof in B position; and/or
one or more ABO₃-perovskites with A bivalent cation and B tetra-valent cation, being at least partially substituted with one or more lower-valent cations, preferably selected from Mg, Sc, Y, Nd and Yb in the B position or with a mixture of different B elements in the B position; and/or
one or more A₂B₂O₇-pyrochlores with A trivalent cation and B tetra-valent cation being at least partially substituted in A position with one or more lower-valent cations, preferentially selected from Ca or Mg, and comprising one or more selected from Sn, Zr and Ti in B position.

For example, the one or more ceramic materials of the anode and/or the cathode further comprise one or more metals selected from nickel, molybdenum, cobalt, and iron. With preference, the one or more ceramic materials of the anode and/or the cathode further comprise nickel.

For example, the one or more ceramic materials have porosity ranging between 15% and 60% according to ASTM C373 standard, or between 30% and 60%.

Advantageously, the one or more protonic membrane reformers have an anode and a cathode and comprise a solid oxide electrolyte between the anode and the cathode.

For example, the anode and/or the cathode and/or the solid oxide electrolyte are or comprise mixed oxides with one or more cations selected from Ba, Zr, Y, Ce, La, Sr, Mn, Fe, Eu, Tb, Ni, Yb, Pr, W, Sm, Zn, Gd, Er, Co, Nd, or any mixture thereof. With preference, the anode and/or the cathode and/or the solid oxide electrolyte are or comprise mixed oxides with one or more cations selected from Ba, Zr, Y, Ce, La, Sr or any mixture thereof.

### DESCRIPTION OF THE FIGURES

FIG. 1: Scheme of the process to produce syngas from methane according to the present disclosure.

FIG. 2: Scheme of the process to produce syngas from methane according to the present disclosure, wherein an additional solid oxide fuel cell is provided.

FIG. 3: Scheme of the process to produce syngas from methane according to the present disclosure where the process is implemented in a stack of four flat cells.

FIG. 4: Scheme of the process to produce syngas from methane according to the present disclosure where the process is implemented in a solid oxide fuel cell shaped as a tubular reactor.

### DETAILED DESCRIPTION

For the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g., from 1.0 to 5.0 includes both 1.0 and 5.0). Any numerical range recited herein is intended to include all sub-ranges subsumed therein.

The particular features, structures, characteristics or embodiments may be combined in any suitable manner, as would be apparent to a person skilled in the art from this disclosure, in one or more embodiments.

The present disclosure relates to a process for producing syngas from methane, the process is remarkable in that it comprises the steps:
a) providing one or more solid oxide fuel cells 1, wherein each of said one or more solid oxide fuel cells 1 has an anode and a cathode and comprises a solid oxide electrolyte between the anode and the cathode; further wherein the anode, the cathode and the solid oxide electrolyte are each composed of one or more ceramic materials;
b) providing a cathode feed stream 3 at the cathode of the one or more solid oxide fuel cells 1, said cathode feed stream 3 being an oxygen-rich stream, to generate oxygen ions diffusing to the anode of the one or more solid oxide fuel cells 1 through the solid oxide electrolyte;
c) providing an anode feed stream 5 at the anode of the one or more solid oxide fuel cells 1, said anode feed stream 5 comprising methane;
d) performing at least a partial oxidation reaction of the methane of the anode feed stream 5 with the oxygen from the oxygen ions generated at step (b) to produce an anodic effluent stream 7 comprising syngas;
e) providing one or more protonic membrane reformers 9 and a stream 11 comprising methane and water;
f) within said one or more protonic membrane reformers 9:
   performing a steam methane reforming reaction with the stream 11 comprising methane and water to generate syngas
   recovering from said syngas at least a carbon oxides-containing stream 13; said carbon oxides-containing stream 13 being at least partially mixed to the anode feed stream 5 provided at step (c).

More particularly, the disclosure relates to a process for producing syngas from methane, the process is remarkable in that it comprises the steps:
a) providing one or more solid oxide fuel cells 1, wherein each of said one or more solid oxide fuel cells 1 has an anode and a cathode and comprises a solid oxide electrolyte between the anode and the cathode; further wherein the anode, the cathode and the solid oxide electrolyte are each composed of one or more ceramic materials;
b) providing a cathode feed stream 3 at the cathode of the one or more solid oxide fuel cells 1, said cathode feed stream 3 being an oxygen-rich stream, to generate oxygen ions diffusing to the anode of the one or more solid oxide fuel cells 1 through the solid oxide electrolyte;
c) providing an anode feed stream 5 at the anode of the one or more solid oxide fuel cells 1, said anode feed stream 5 comprising methane;
d) performing at least a partial oxidation reaction of the methane of the anode feed stream 5 with the oxygen from the oxygen ions generated at step (b) to produce an anodic effluent stream 7 comprising syngas;
e) providing one or more protonic membrane reformers 9, and a stream 11 comprising methane and water;
f) within said one or more protonic membrane reformers 9:
   performing a steam methane reforming reaction with the stream 11 comprising methane and water to generate syngas; and
   recovering from said syngas at least a carbon oxides-containing stream 13, said carbon oxides-containing stream 13 being at least partially mixed to the anode feed stream 5 provided at step (c); and
wherein each of said one or more protonic membrane reformers 9 has an anode and a cathode, and the anode of said each of the one or more protonic membrane reformers 9 is directly adjacent with the anode of said each of the one or more solid oxide fuel cells 1 provided at step (a); and/or
wherein step (a) is the step of providing at least one solid oxide fuel cell 1 presenting a solid oxide electrolyte into which one protonic membrane reformer 9 provided at step (e) is inserted.

The present process uses one or more protonic membrane reformers 9 to set up an overall process for the generation of syngas from methane. The overall process will produce syngas with a molar ratio between the amount of hydrogen and the amount of carbon monoxide being 2/1, since the one or more protonic membrane reformers 9 will generate a carbon oxides-containing stream 13 which is then injected into the one or more solid oxide fuel cells 1, for increasing the amount of carbon oxides into the anodic effluent stream 7 comprising syngas produced at step (d). The overall process will further produce enough energy that could be recovered to work the one or more protonic membrane reformers 9.

The following three chemical equations detail the reactions happening in the process of the disclosure as well as their enthalpies.

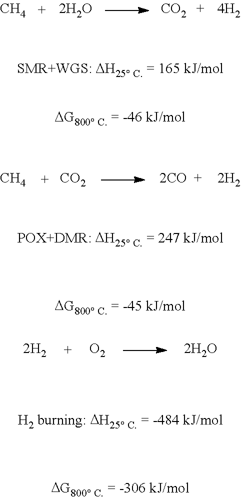

The first reaction, which is a combination of SMR and WGS, occurs in the one or more protonic membrane reformers 9, while the second reaction (combination of POX and DMR) and the third reaction (H₂ burning) occur in the one or more solid oxide fuel cells 1, along with electrical energy production that can be preferably used to work the one or more protonic membrane reformers 9.

Overall, the process of the present disclosure can be summed up in the following chemical reaction:

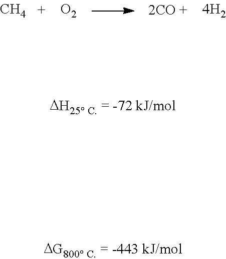

It can be therefore seen that syngas with a ratio between the amount of hydrogen and the amount of carbon monoxide of 2/1 is generated exothermically.

The fact that the one or more protonic membrane reformers 9 can split the syngas into one carbon oxides-containing stream 13 and one hydrogen stream 19, the recovery of the hydrogen stream 19 being optional, makes it possible to adjust the molar ratio between the methane and the carbon dioxide in the anode feed stream 5, and therefore to modulate the amount of hydrogen and the amount of carbon monoxide into the syngas. This also enables to use of at least a part of the hydrogen stream 19 and/or at least a part of the carbon oxides-containing stream 13 separately.

Advantageously, the carbon oxides-containing stream has a molar ratio (CO+CO₂)/H₂ of at least 0.5, preferably at least 0.75, and more preferably at least 0.90.

Advantageously, recovering from said syngas at least a carbon oxides-containing stream also comprises removing at least 40 vol. % of hydrogen based on the total volume content of the hydrogen in the syngas as determined by gas chromatography analysis, or at least 50 vol. %, more preferably at least 55 vol. %, even more preferably at least 60 vol. %, most preferably at least 65 vol. %, even most preferably at least 70 vol. %, or at least 80 vol. %, or at least 90 vol. %, or at least 95 vol. %, or at least 99 vol. % of hydrogen.

Advantageously, the carbon oxides-containing stream comprises at least 1 mol. % of hydrogen based on the total molar content of the carbon oxides-containing stream, preferably at least 2 mol. %, more preferably at least 3 mol. %, even more preferably at least 4 mol. %, most preferably at least 5 mol. %. For example, the carbon oxides-containing stream comprises at most 67 mol. % of hydrogen based on the total molar content of the carbon oxides-containing stream, preferably at most 65 mol. %, more preferably at most 60 mol. %, even more preferably at most 55 mol. %, most preferably at most 50 mol. %, or at most 45 mol. %, or at most 40 mol. %, or at most 35 mol. %, or at most 30 mol. %. For example, the carbon oxides-containing stream comprises between 1 mol. % and 67 mol. % of hydrogen based on the total molar content of the carbon oxides-containing stream, preferably between 2 mol. % and 65 mol. %, more preferably between 3 mol. % and 60 mol. %, even more preferably between 4 mol. % and 55 mol. %, most preferably between 5 mol. % and 50 mol. %.

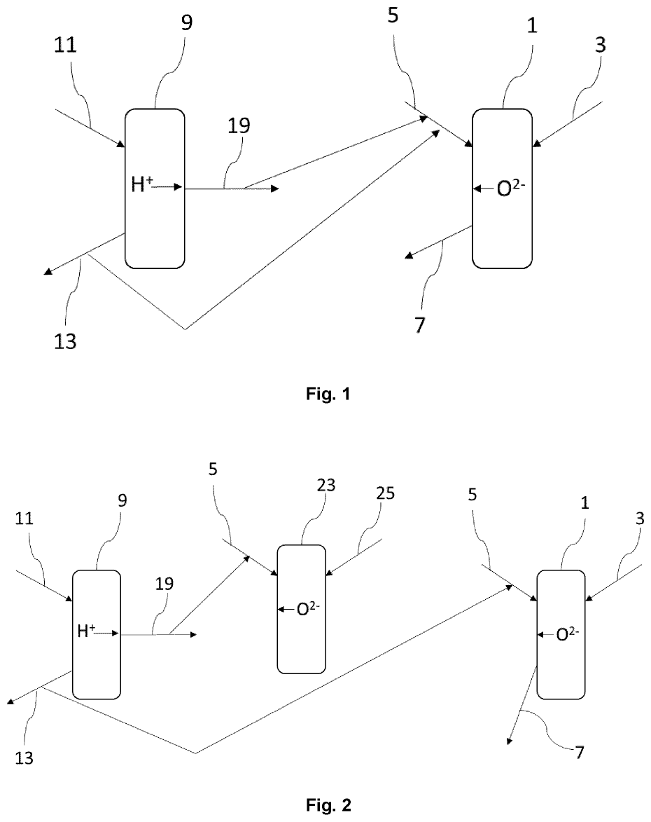

In FIG. 1, it is shown that the generation of a carbon oxides-containing stream 13 allows performing dry methane reforming reaction of the methane of the anode feed stream 5 simultaneously to the partial oxidation reaction of step (d) and to the burning of hydrogen which has for effect to boost the efficiency of the reaction in term of energy. This could be the case when electricity is expensive. As shown by the highly negative enthalpy of the oxidation reaction of hydrogen, it is advantageous to burn hydrogen to increase the exothermicity of the overall process. When electricity is cheap, production of hydrogen in the one or more protonic membrane reformers 9 can thus be enhanced and hydrogen could be then stored. In the one or more solid oxide fuel cells 1, there is then focus to convert carbon dioxide into carbon monoxide, making thus the process CO₂ negative.

In addition, the hydrogen stream 19, when recovered, can be mixed at the anode of the one or more solid oxide fuel cells 1 and/or into the anodic effluent stream 7 produced at step (d), and optionally to the anode feed stream 5 provided at step (c). Furthermore, the hydrogen stream 19 can be stored and potentially used in other processes. When the hydrogen stream 19 is mixed to the anodic effluent stream 7, it is thus possible to adjust the content of the hydrogen into the syngas present in the anodic effluent stream 7 produced at step (d). This adjustment of the ratio between hydrogen and carbon monoxide is thus done with hydrogen of high quality. When the hydrogen stream 19 is mixed to the anode feed stream 5 provided at step (c), it allows to boost the reaction by giving more power.

Optionally, the process can comprise a separation step to separate the carbon dioxide and the carbon monoxide from at least a part of the carbon oxides-containing stream 13 and/or from at least a part of the anodic effluent stream 7. With preference, said carbon dioxide is mixed to the anode feed stream 5 of the solid oxide fuel cell 1. Optionally, a part of the hydrogen stream 19 can be mixed to the anode feed stream 5 of the solid oxide fuel cell 1. This allows performing dry methane reforming reaction of the methane of the anode feed stream 5 simultaneously to the partial oxidation reaction of step (d) and to the burning of hydrogen which has for effect to boost the efficiency of the reaction in terms of energy. As shown by the highly negative enthalpy of the oxidation reaction of hydrogen, it is advantageous to burn hydrogen to increase the exothermicity of the overall process.

Optionally, the process can comprise a separation step to separate the carbon dioxide from the carbon oxides-containing stream 13. With preference, said carbon dioxide is mixed with the anode feed stream 5 of the one or more solid oxide fuel cells 1.

Advantageously and especially when electricity is expensive, as indicated in FIG. 2, the process comprises a step of providing one or more additional solid oxide fuel cells 23, wherein each of said one or more additional solid oxide fuel cells 23 has an anode and a cathode, and comprises a solid oxide electrolyte between the anode and the cathode; further wherein the anode, the cathode and the solid oxide electrolyte are each composed of one or more ceramic materials and in that a cathode feed stream 25 is provided at the cathode of the one or more additional solid oxide fuel cells 23, said cathode feed stream 25 being an oxygen-rich stream, such as air or oxygen-enriched air, to generate oxygen ions diffusing to the anode of the one or more additional solid oxide fuel cells 23 through the solid oxide electrolyte, and wherein at least a part of the hydrogen stream 19 is mixed to the anode of said one or more additional solid oxide fuel cells 23 and/or to the anode feed stream 5 provided at step (c) so as to produce additional electrical energy, which can be used to worked the one or more protonic membrane reformers 9. Indeed, as explained above, the burning of hydrogen is an exothermic reaction that is here used to decrease the electrical energy requirements of the overall process. When electricity is expensive, the duty of the one or more protonic membrane reformers 9 can be decreased, removing thus less hydrogen, but allowing the use of at least a part of the hydrogen stream 19, and/or the previously stored hydrogen, in one or more additional solid oxide fuel cells 23, which will then run only on hydrogen. For example, in such operation, the recovering from said syngas at least a carbon oxides-containing stream also comprises removing from 40 vol. % up to 60 vol. % of hydrogen based on the total volume content of the syngas as determined by gas chromatography analysis, or from 45 vol. % up to 55 vol. %.

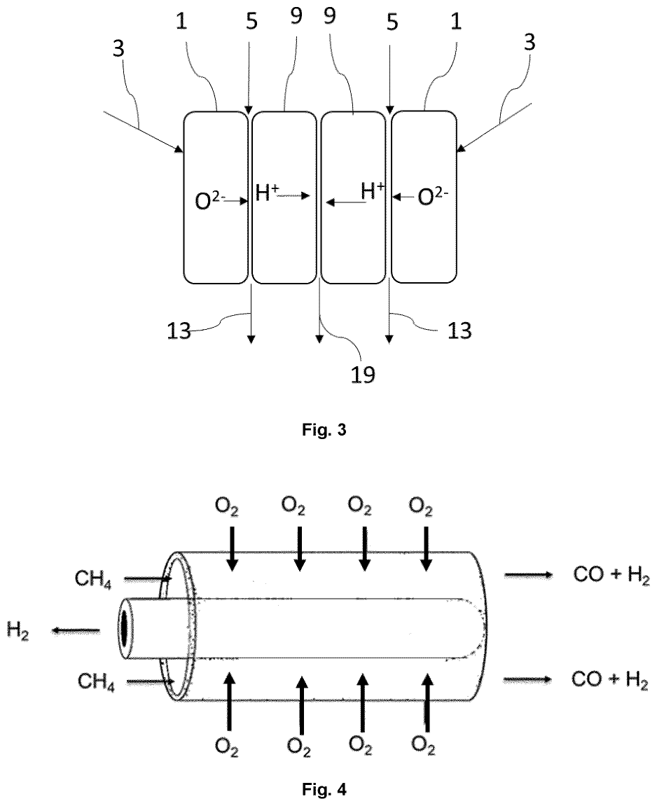

FIG. 3 represents the process to produce syngas from methane according to the present disclosure where the process is implemented in a stack of four flat cells. There are at least two solid oxide fuel cells 1 wherein the anode of each solid oxide fuel cell 1 is directly adjacent to the anode of a protonic membrane reformer 9. In that configuration, the process is for example performed in an installation made of a stack of four flat cells, wherein the first cell is a first solid oxide fuel cell 1, the second cell is a first protonic membrane reformer 9 and is placed contiguously with the first cell, the third cell is a second protonic membrane reformer 9 and is placed contiguously with the second cell, and the fourth cell is a second solid oxide fuel cell 1 and is placed contiguously with the third cell. Therefore, the syngas that is produced is directly separated upon its production, which has the benefit to lead to two separate streams that can in a later step be recombined at the desired molar ratio between the amount of methane and the amount of carbon dioxide to obtain a syngas with a specific ratio between the amount of hydrogen and the amount of carbon monoxide. Advantageously, the separated hydrogen and carbon monoxide can be used in other applications or for other processes. For example, hydrogen can be used as fuel for transportation. It is highlighted that both the solid oxide fuel cells and both the protonic membrane reformers function and/or are set up in the same manner. Alternatively, the process is performed in an installation made of a stack of four flat cells, wherein the first cell is a first protonic membrane reformer 9, the second cell is a first solid oxide fuel cell 1 and is placed contiguously with the first cell, the third cell is a second solid oxide fuel cell 1 and is placed contiguously with the second cell, and the fourth cell is a second protonic membrane reformer 9 and is placed contiguously with the third cell.

Channels can be disposed between the cells, for allowing the passage of the gas.

In this stack of four flat cells, the one or more protonic membrane reformers provided at step (e) are operated at a temperature which is equal to the temperature used in the one or more solid oxide fuel cells. For example, the first and second solid oxide fuel cells are operating at a temperature ranging between 600° C. and 1000° C., preferably between 650° C. and 950° C., more preferably between 700° C. and 900° C.; and the first and second protonic membrane reformers are operating at the same temperature as the first and second solid oxide fuel cells.

FIG. 4 represents the process to produce syngas from methane according to the present disclosure where the process is implemented in a solid oxide fuel cell shaped as a tubular reactor. The solid oxide electrolyte of the solid oxide fuel cell presents an inserted protonic membrane reformer. More particularly, the process is performed in an installation made of a solid oxide fuel cell shaped as a tubular reactor filled with one or more solid oxide electrolytes into which a protonic membrane reformer in the form of a tube or a closed tube is inserted.

For example, the temperature of the solid oxide fuel cell shaped as a tubular reactor is ranging between 600° C. and 1000° C., preferably between 650° C. and 950° C., more preferably between 700° C. and 900° C. This is another case where the temperature of the protonic membrane reformer is equal to the temperature of the solid oxide fuel cell.

To implement a carbon dioxide negative technology whichever the embodiment, the process comprises the step of adding carbon dioxide into the anode feed stream 5 provided in step (c). This step is giving value to the present process since it is nowadays required to eliminate greenhouse gases for environmental reasons. This step is particularly advantageous when the molar ratio in the anode feed stream 5 provided at step (c) between the amount of methane and the amount of carbon dioxide is 2/1 or lower.

To improve the exothermicity of the process, whichever the embodiment is implemented, the process comprises the step of adjusting the anode feed stream 5 provided in step (c) by adding more methane into it. This step is particularly advantageous when the molar ratio in the anode feed stream 5 provided at step (c) between the amount of methane and the amount of carbon dioxide is 2/1 or higher since it allows to establish an exothermic reaction, according to the following chemical equation:

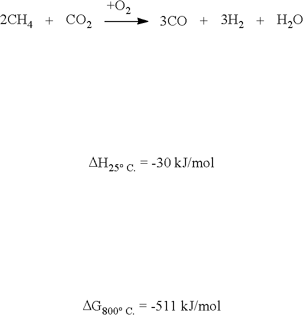

Generally, for Y≥2(X−2):

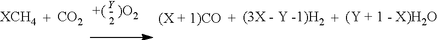

For example, the molar ratio in the anode feed stream provided at step (c) between the amount of methane and the amount of carbon dioxide is at least 1.5/1, preferably at least 2/1, more preferably at least 3/1, and even more preferably at least 4/1.

The following chemical equations show that the exothermicity of the reaction of syngas generation is improved when the molar ratio between the amount of methane and the amount of carbon dioxide is increased.

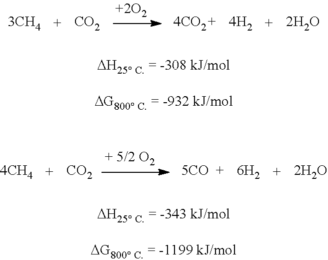

Advantageously, the one or more protonic membrane reformers 9 provided at step (e) are operated at a temperature which is equal to or inferior to the temperature used in the one or more solid oxide fuel cells 1 or the one or more additional solid oxide fuel cells 23.

For example, the one or more protonic membrane reformers 9 provided at step (e) are operated at a temperature ranging between 400° C. and 900° C., preferably between 450° C. and 850° C., more preferably between 500° C. and 800° C.

For example, the one or more solid oxide fuel cells 1 are operated at a temperature ranging between 600° C. and 1000° C., preferably between 650° C. and 950° C., more preferably between 700° C. and 900° C.

For example, the one or more additional solid oxide fuel cells 23 are operated at a temperature ranging between 600° C. and 1000° C., preferably between 650° C. and 950° C., more preferably between 700° C. and 900° C.

For example, the one or more protonic membrane reformers 9 are operated at a current density that is ranging between 0.2 A/cm² and 10 A/cm², or between 0.2 A/cm² and 8 A/cm², or between 0.2 A/cm² and 6 A/cm², or between 0.2 A/cm² and 5 A/cm², preferably between 0.4 A/cm² and 4 A/cm².

For example, the one or more solid oxide fuel cells 1 are operated at a current density that is ranging between 0.05 A/cm² and 5 A/cm², or between 0.1 A/cm² and 4 A/cm², or between 0.2 A/cm² and 3 A/cm², or between 0.2 A/cm² and 2 A/cm², preferably between 0.2 A/cm² and 1.8 A/cm², more preferably between 0.2 A/cm² and 1.6 A/cm², even more preferably between 0.2 A/cm² and 1.4 A/cm².

For example, the one or more additional solid oxide fuel cells 23 are operated at a current density that is ranging between 0.05 A/cm² and 5 A/cm², or between 0.1 A/cm² and 4 A/cm², or between 0.2 A/cm² and 3 A/cm², or between 0.2 A/cm² and 2 A/cm², preferably between 0.2 A/cm² and 1.8 A/cm², more preferably between 0.2 A/cm² and 1.6 A/cm², even more preferably between 0.2 A/cm² and 1.4 A/cm².

To prevent the coking the one or more ceramic materials that act as a catalyst, it is advantageous that the process further comprises the step of adding water into the anode feed stream 5 provided in step (c). With preference, the molar amount of water in the anode feed stream is therefore ranging between 0 mol. % and 10 mol. % based on the total molar content of the anode feed stream provided at step (c), between 0.5 mol. % and 9 mol. %, or between 1 mol. % and 9 mol %, even more preferably between 2 mol. % and 8 mol. %, or between 3 mol. % and 7 mol. %.

For example, the anode feed stream 5 provided in step (c) is a stream of natural gas, biogas, fuel gas, sour gas, or any mixture thereof. Biogas is a stream having a methane content between 50-80 vol. % based on the total volume of said biogas, and carbon dioxide content between 15-50 vol. % based on the total volume of said biogas. Sour gas is a stream of natural gas having a significant amount of hydrogen disulphide, for example up to 50 ppm of hydrogen disulphide.

For example, the cathode feed stream 3 provided at step (b) is air or oxygen-enriched air.

### The Materials of the One or More Solid Oxide Fuel Cells 1 or of the One or More Additional Solid Oxide Fuel Cells 23

The one or more ceramic materials are one or more mixed oxides.

Advantageously, the one or more solid oxide fuel cells 1 and/or the one or more additional solid oxide fuel cells 23 comprise a layer between the anode and the solid oxide electrolyte and/or between the cathode and the solid oxide electrolyte. With preference, said layer is made of one or more ceramic materials, more preferably of one or more mixed oxides. In such a configuration, it is preferred that the solid oxide electrolyte is made of one first mixed oxide, the layer between the anode and the solid oxide electrolyte and/or between the cathode and the solid oxide electrolyte being a layer made of a second mixed oxide different from the first mixed oxide, and the anode and/or the cathode being made of a mixture comprising said second mixed oxide and one or more metals selected from nickel, molybdenum, cobalt, and iron.

In an embodiment, the mixed oxides can be one or more oxides having a cubic fluorite structure being at least partially substituted with one or more lower-valent cations, preferentially selected from Sm, Gd, Y, Sc, Yb, Mg, Ca, La, Dy, Er, Eu, Ba.

The mixed oxides can also be one or more ABO₃-perovskites with A and B tri-valent cations, being at least partially substituted in A position with one or more lower-valent cations, preferentially selected from Ca, Sr, or Mg, and comprising one or more selected from Ni, Ga, Co, Cr, Mn, Sc, Fe and a mixture thereof in the B position.

The mixed oxides can further be one or more ABO₃-perovskites with A bivalent cation and B tetra-valent cation, being at least partially substituted with one or more lower-valent cations, preferentially selected from Mg, Sc, Y, Nd or Yb in the B position or with a mixture of different B elements in the B position.

The mixed oxides can be in other examples one or more A₂B₂O₇-pyrochlores with A trivalent cation and B tetra-valent cation being at least partially substituted in A position with one or more lower-valent cations, preferentially selected from Ca or Mg, and comprising one or more selected from Sn, Zr and Ti in B position.

With preference, the degree of substitution in the one or more mixed oxides doped with one or more lower-valent cations is between 1 and 50 atom % based on the total number of atoms present in the one or more oxides having a cubic fluorite structure, in the one or more ABO₃-perovskites with A and B tri-valent cations, in the one or more ABO₃-perovskites with A bivalent cation and B tetra-valent cation or in the one or more A₂B₂O₇-pyrochlores with A trivalent cation and B tetra-valent cation respectively, preferably between 3 and 20 atom %, more preferably between 5 and 15 atom %.

Said one or more oxides having a cubic fluorite structure, said one or more ABO₃-perovskites with A and B tri-valent cations, said one or more ABO₃-perovskites with A bivalent cation and B tetra-valent cation or said one or more A₂B₂O₇-pyrochlores with A trivalent cation and B tetra-valent cation being at least partially substituted with lower valent cations, also means that the same element, being a high-valent cation, can be reduced in the lower-valent equivalent, for example:
Ti(IV) can be reduced in Ti(III); and/or
Co(Ill) can be reduced in Co(II); and/or
Fe(Ill) can be reduced in Fe(II); and/or
Cu(II) can be reduced in Cu(I).

For example, the one or more ceramic materials of the anode and/or the cathode further comprise one or more metals selected from nickel, molybdenum, cobalt, or iron. With preference, the one or more ceramic materials of the anode and/or the cathode further comprise nickel.

For example, the one or more ceramic materials of the anode and/or the cathode are nickel/yttria-stabilized zirconia (Ni-YSZ) or lanthanum strontium manganese oxide-YSZ (LSM-YSZ).

For example, the one or more ceramic materials have porosity ranging between 15% and 60% according to ASTM C373 standard, or between 30% and 60%. Porosity is defined as the ratio of the volume of the voids or the pore space divided by the total volume. In other words, it is the percentage of void space in the ceramic material.

### The Materials of the One or More Protonic Membrane Reformers 9

Advantageously, the one or more protonic membrane reformers 9 have an anode and a cathode and comprise a solid oxide electrolyte between the anode and the cathode.

For example, the anode and/or the cathode and/or the solid oxide electrolyte are or comprise mixed oxides with one or more cations selected from Ba, Zr, Y, Ce, La, Sr, Mn, Fe, Eu, Tb, Ni, Yb, Pr, W, Sm, Zn, Gd, Er, Co, Nd, or any mixture thereof. These mixed oxides have high proton conductivity. With preference, the anode and/or the cathode and/or the solid oxide electrolyte are or comprise mixed oxides with one or more cations selected from Ba, Zr, Y, Ce, La, Sr or any mixture thereof.

For example, the anode and the cathode further comprise one or more of BaZr_{0.8}Y_{0.15}Mn_{0.05}O_{3-δ}, BaZr_{0.90}Fe_{0.10}O_{3-δ}, SrCe_{0.7}Zr_{0.2}Eu_{0.1}O_{3-δ}, BaCe_{0.95}Tb_{0.05}O_{3-δ}, Ni/BaZr_{0.1}Ce_{0.7}Y_{0.1}Yb_{0.1}O_{3-δ}, Ni/BaZr_{0.1}Ce_{0.7}Y_{0.2}O_{3-δ}, Ni/BaCe_{0.8}Y_{0.2}O_{3-δ}, Ni/BaCe_{0.95}Tb_{0.05}O_{3-δ}, Ni/BaZr_{0.7}Pr_{0.1}Y_{0.2}O_{3-δ}, Ni/BaZr_{0.1}Ce_{0.7}Y_{0.2}O_{3-δ}, Ni/Ba_{0.8}Ce_{0.35}Zr_{0.5}Tb_{0.15}O_{3-δ}, La_{5.5}WO_{11.25-δ}, La_{0.87}Sr_{0.13}CrO_{3-δ}, BaCe_{0.8}Y_{0.2}O_{3-δ}/Ce_{0.8}Y_{0.2}O_{2-δ}, or any mixture thereof.

For example, the solid oxide electrolyte comprises SrCe_{0.95}Yb_{0.05}O_{3-δ}, SrZr_{0.95}Y_{0.05}O_{3-δ}, BaCe₁₋ₓYₓO_{3-δ}, SrCe_{0.95}Yb_{0.05}O_{3-δ}, BaCe_{0.7}Zr_{0.2}Sm_{0.1}O_{3-δ}, Ba_{0.98}Ce_{0.8}Y_{0.2}O_{3-δ}+0.04 ZnO, BaCe_{0.5}Zr_{0.3}Y_{0.16}Zn_{0.04}O_{3-δ}, Zr_{0.7}Ce_{0.2}Y_{0.1}O_{2.9}, BaCe_{0.85}Gd_{0.15}O_{3-δ}, BaCe_{0.85-x}ZrₓEr_{0.15}O_{3-δ}, BaCe_{0.85}Gd_{0.15}O_{3-δ}.

1-24. (canceled)

25. A process for producing syngas from methane, the process is characterized in that it comprises the steps:
a. providing one or more solid oxide fuel cells (1), wherein each of said one or more solid oxide fuel cells (1) has an anode and a cathode and comprises a solid oxide electrolyte between the anode and the cathode; further wherein the anode, the cathode and the solid oxide electrolyte are each composed of one or more ceramic materials;
b. providing a cathode feed stream (3) at the cathode of the one or more solid oxide fuel cells (1), said cathode feed stream (3) being an oxygen-rich stream, to generate oxygen ions diffusing to the anode of the one or more solid oxide fuel cells (1) through the solid oxide electrolyte;
c. providing an anode feed stream (5) at the anode of the one or more solid oxide fuel cells (1), said anode feed stream (5) comprising methane;
d. performing at least a partial oxidation reaction of the methane of the anode feed stream (5) with the oxygen from the oxygen ions generated at step (b) to produce an anodic effluent stream (7) comprising syngas;
e. providing one or more protonic membrane reformers (9) and a stream (11) comprising methane and water;
f. within said one or more protonic membrane reformers (9):
i. performing a steam methane reforming reaction with the stream (11) comprising methane and water to generate syngas; and
ii. recovering from said syngas at least a carbon oxides-containing stream (13), said carbon oxides-containing stream (13) being at least partially mixed to the anode feed stream (5) provided at step (c);
wherein each of said one or more protonic membrane reformers (9) has an anode and a cathode, and the anode of said each of the one or more protonic membrane reformers (9) is directly adjacent with the anode of said each of the one or more solid oxide fuel cells (1) provided at step (a).

26. The process according to claim 25 is characterized in that step (d) also produces electrical energy.

27. The process according to claim 26, characterized in that said electrical energy is used to work the one or more protonic membrane reformers (9) provided in step (e).

28. The process according to claim 25 is characterized in that the process comprises the step of adding carbon dioxide into the anode feed stream (5) provided at step (c).

29. The process according to claim 25, characterized in that the molar ratio in the anode feed stream (5) provided at step (c) between the amount of methane and the amount of carbon dioxide is at least 2/1.

30. The process according to claim 25 is characterized in that the carbon oxides-containing stream (13) has a molar ratio (CO+CO₂)/H₂ of at least 0.5.

31. The process according to claim 25 is characterized in that recovering from said syngas at least a carbon oxides-containing stream also comprises removing at least 40 vol. % of hydrogen based on the total volume content of hydrogen in the syngas as determined by gas chromatography analysis.

32. The process according to claim 25 is characterized in that the carbon oxides-containing stream (13) comprises at least 1 mol. % of hydrogen based on the total molar content of the carbon oxides-containing stream (13).

33. The process according to claim 25 is characterized in that said process further comprises a step of recovering a hydrogen stream (19), and in that at least a part of the hydrogen stream (19) is mixed to the anodic effluent stream (7) produced at step (d).

34. The process according to claim 25 is characterized in that at least a part of the carbon oxides-containing stream (13) is separated into a carbon dioxide stream and a carbon monoxide stream.

35. The process according to claim 34, characterized in that said carbon dioxide stream is mixed to the anode feed stream (5) of the solid oxide fuel cell.

36. The process according to claim 25 is characterized in that at least a part of the anodic effluent stream (7) is separated into a carbon dioxide stream and a carbon monoxide stream.

37. The process according to claim 36, characterized in that said carbon dioxide stream is mixed to the anode feed stream (5) of the solid oxide fuel cell.

38. The process according to claim 25 is characterized in that the process comprises a step of providing one or more additional solid oxide fuel cells (23), wherein each of said one or more additional solid oxide fuel cells (23) has an anode and a cathode, and comprises a solid oxide electrolyte between the anode and the cathode; further wherein the anode, the cathode and the solid oxide electrolyte are each composed of one or more ceramic materials and in that a cathode feed stream (25) is provided at the cathode of the one or more additional solid oxide fuel cells (23), said cathode feed stream (25) being an oxygen-rich stream, to generate oxygen ions diffusing to the anode of the one or more additional solid oxide fuel cells (23) through the solid oxide electrolyte, and wherein at least a part of the hydrogen stream (19) is mixed to the anode of said one or more additional solid oxide fuel cells (23) so as to produce additional electrical energy.

39. The process according to claim 38, characterized in that said additional electrical energy is used to work the one or more protonic membrane reformers (9) provided in step (e).

40. The process according to claim 25 is characterized in that the one or more protonic membrane reformers provided at step (e) are operated at a temperature which is equal to or inferior to the temperature used in the one or more solid oxide fuel cells.

41. The process according to claim 25 is characterized in that the process further comprises the step of adding water into the anode feed stream (5) provided in step (c).

42. The process according to claim 25 is characterized in that the anode feed stream (5) provided at step (c) is a stream of natural gas, biogas, fuel gas, sour gas, or any mixture thereof.

43. The process according to claim 25, characterized in that cathode feed stream (3) provided at step (b) is air.

44. The process according to claim 25 is characterized in that the one or more ceramic materials are one or more mixed oxides.
